(19) United States
(12) Patent Application Publication
(10) Pub. No.: US 2018/0258766 A1
(43) Pub. Date: Sep. 13, 2018

(54) FIRE-RESISTANT ELEMENT FOR COVERING A CONCRETE SURFACE

(71) Applicant: Promat B.V., Houten (NL)

(72) Inventors: Bart De Vries, Houten (NL); Martin Boot, Houten (NL); Herman KUIPER, Houten (NL)

(21) Appl. No.: 15/764,658

(22) PCT Filed: Oct. 28, 2016
(86) PCT No.: PCT/NL2016/050750

§ 371 Date: Mar. 29, 2018

(30) Foreign Application Priority Data
Oct. 29, 2015 (NL) 2015688

(51) Int. Cl. E21D 11/38; E21D 11/10; C09K 21/02

(52) U.S. Cl. CPC E21D 11/38; C09K 21/02; E21D 11/10

(57) ABSTRACT

The invention relates to a construction element (4 for covering a concrete surface (20), a construction comprising said construction element (4) and a method for covering a concrete surface (20) with said construction elements (4). The construction element (4) is provided with a plurality of anchoring elements (5) for anchoring the construction element to the concrete (9) when it is casted, wherein each anchoring element (5) comprises an opening (51) which is arranged to be in fluid communication with the concrete (9), a base (52) that is recessed and a circumferential wall (53) extending between the opening (51) and the base (52), wherein the circumferential wall (53) defines a volume for receiving the concrete (9) into the anchoring element (5), wherein each anchoring element (5) comprises at least one locking surface (6) that faces said volume and that is arranged to stop movement of the concrete (9) from the base (52) towards the opening (51), after the concrete (9) has cured, in an anchoring direction.

### BACKGROUND

The invention relates to a construction element for covering a concrete surface, in particular a concrete surface of a tunnel. In particular, the construction element is a fireproofing construction element for lining the inside of a tunnel.

Known fireproofing plates for tunnels are placed onto the formwork of a tunnel prior to casting of the concrete in said formwork. The fireproofing plates are arranged to cover the side of the formwork that faces the inside of the tunnel, so that after removal of the formwork, the fireproofing plates are on the inside of the tunnel. The adherence of the concrete to the fireproofing plates has proven to be insufficient to securely retain the fireproofing plates to the concrete, in particular when the fireproofing plates are arranged to cover the ceiling of the tunnel. To attach the fireproofing plates to the concrete, a considerable number of screws are mounted into the fireproofing plates, which screws protrude from the fireproofing plates at the side where the concrete is cast. When the concrete is cast and ultimately cures, the screws are anchored in the cured concrete and prevent that the fireproofing plates detach from the cured concrete. To ensure a proper anchoring of the fireproofing plates to the concrete, up to ten screws per square meter have to be mounted into the fireproofing plates. One can imagine that for the huge surface area of a typical tunnel to be covered with fireproofing plates, the mounting of screws consumes valuable time and resources.

It is an object of the present invention to provide an alternative for covering a concrete surface, which can be anchored with respect to the concrete more easily.

### SUMMARY OF THE INVENTION

According to a first aspect, the invention provides a construction element for covering a concrete surface, in particular a concrete surface of a tunnel, wherein the concrete surface is formed by casting concrete, wherein the construction element comprises a plate-like body with a first side that is arranged to face away from the concrete when it is casted and a second side opposite to the first side that is arranged to face the concrete when it is casted, wherein the construction element is provided with a plurality of anchoring elements at the second side for anchoring the construction element to the concrete when it is casted, wherein each anchoring element comprises an opening in the second side, which opening is arranged to be in fluid communication with the concrete, a base that is recessed with respect to the second side towards the first side and a circumferential wall extending between the opening and the base, wherein the circumferential wall defines a volume for receiving the concrete into the anchoring element, wherein each anchoring element comprises at least one locking surface that faces said volume and that is arranged to stop movement of the concrete from the base towards the opening, after the concrete has cured, in an anchoring direction normal to the second side.

The anchoring elements can receive the concrete during casting and can geometrically enclose or lock in parts of the cured concrete inside their respective volumes to prevent or stop retraction or movement of said parts of the cured concrete in the anchoring direction. The anchoring can occur automatically upon curing of the concrete. The concrete itself can provide the mechanical connecting between the concrete and the construction elements. No additional elements other than the construction elements themselves are required to securely anchor the construction elements to the concrete. Therefore, the screws according to the prior art can be dispensed with all together, reducing the time and efforts involved with anchoring the construction elements. Unlike the screws of the prior art, the anchoring elements according to the invention are not visible at the first side of the construction element.

In an embodiment the at least one locking surface is arranged to abut or to exert a stopping force onto the concrete in an abutment direction opposite to the anchoring direction. By abutting or exerting a force onto the concrete in the abutment direction, the locking surface can prevent movement or retraction of the concrete in the opposite anchoring direction.

In an embodiment at least a part of the plate-like body extends between the at least one locking surface and the second side in the anchoring direction. This part of the plate-like body can effectively geometrically enclose or lock in the part of the concrete located underneath said part of the plate-like body in the anchoring direction.

In an embodiment the at least one locking surface extends obliquely with respect to the anchoring direction. Preferably, the angle of the at least one locking surface with respect to the anchoring direction is in the range of thirty to eighty degrees, and preferably in the range of forty to seventy degrees. The angle can improve the quality of the anchoring. The anchoring can become more secure with a greater angle.

In an embodiment the locking surface is formed by a wall section of the circumferential wall that diverges from the opening towards the base. The wall section can face, retain and/or anchor a part of the concrete in the volume in the abutment direction.

In an embodiment the base is larger than opening. Thus, concrete with a greater dimension than the opening can be collected at the base, which concrete can no longer be retracted through the opening in the anchoring direction after the concrete has cured.

In an embodiment that can be easy to manufacture, the base has the same geometric shape as the opening.

In an embodiment the volume at the at least one locking surface has the form of a truncated cone or a truncated pyramid. Again, the base of said truncated cone or truncated pyramid is larger than the opening. Thus, concrete with a greater dimension than the opening can be collected at the base, which concrete can no longer be retracted through the opening in the anchoring direction after the concrete has cured.

In an alternative embodiment the base is offset with respect to the opening in a direction transverse or perpendicular to the anchoring direction. The part of the concrete at the offset base can no longer be retracted through the opening in the anchoring direction after the concrete has cured.

In an embodiment thereof the bases of at least two of the plurality of anchoring elements are offset in different directions with respect to each other. The different offset direction of the base of one of two the anchoring elements can prevent that the concrete moves under an oblique angle with respect to the anchoring direction, in line with the base and the opening of the other of the two anchoring elements.

In a further alternative embodiment each anchoring element comprises a plurality of locking surfaces arranged consecutively in the anchoring direction, wherein each locking surface is arranged to individually abut the concrete in the abutment direction opposite to the anchoring direction. By providing a plurality of locking surface, the contact surface with the concrete in the abutment direction can be increased, thereby increasing the quality of the anchoring.

In an embodiment thereof the plurality of locking surfaces are formed by a plurality of wall sections, respectively. Preferably, each wall section diverges from the opening towards the base. Thus, the wall sections can each individually contribute to the quality of the anchoring.

In an embodiment the at least one locking surface forms the entire circumferential wall. The circumferential wall can thus be optimally used as a locking surface for retaining the concrete.

In a further alternative embodiment the at least one locking surface forms a recess in the circumferential wall extending in a direction transverse or perpendicular to the anchoring direction. The recess, similarly to the offset base, can collect concrete which, after curing, can no longer be retracted through the opening in the anchoring direction.

In a preferred embodiment thereof the recess is spaced apart from the base.

In a further alternative embodiment the at least one locking surface is formed by a protrusion that protrudes into the volume. A protrusion can provide or form the locking surface inside or within the volume, independently from the shape of the circumferential wall.

Preferably the protrusion protrudes from the circumferential wall, in which case the protrusion may be formed as a rim extending circumferentially on the inside of the circumferential wall and/or extending helically in the anchoring direction. The concrete that is located between the locking surface at the protrusion and the base can be locked in against retraction in the anchoring direction.

Alternatively, the protrusion protrudes from the base, in which case the protrusion may be provided with a head that forms the at least one locking surface and a body connecting the head to the base. The protrusion can be formed completely independently from the circumferential wall. Again, the concrete that is located between the locking surface at the protrusion and the base can be locked in against retraction in the anchoring direction.

In an embodiment the opening and/or the base have a geometric shape of the group comprising a circle, an oval, a triangle, a square, a rectangle, a pentagon, a hexagon, or any other polygon. Any of these geometric shapes may be suitable to form the opening and/or the base of the anchoring elements according to the invention.

In a fireproofing application the plate-like body comprises fireproofing material, preferably non-combustible mineral board reinforced with fibers and/or fillers. The fireproofing construction elements can be used to protect the concrete of the tunnel against a fire in the internal tunnel volume.

According to a second aspect, the invention provides a computer-readable medium having computer-executable instructions adapted to cause a 3D printer to print the aforementioned construction element.

By using a 3D printer, certain anchoring elements can be formed in the plate-like body of the construction element which would not be possible with traditional manufacturing techniques. Moreover, the construction elements can be printed on-site, on demand and can be customized to the specific requirements of the tunnel.

According to a third aspect, the invention provides a construction, in particular a tunnel, comprising a cured concrete layer with a concrete surface and a plurality of the aforementioned construction elements covering said concrete surface, wherein the construction elements are anchored to the cured concrete layer by parts of the cured concrete layer extending in at least some of the volumes of the respective anchoring elements.

The construction with said construction elements can provide one or more of the same advantages as described in relation to the aforementioned embodiments. These advantages are not repeated hereafter for reasons of conciseness.

In an embodiment of the construction, the construction elements are fully and/or solely supported by the parts of the cured concrete layer in the plurality of anchoring elements after the curing of the concrete. Thus, the construction can be constructed without using additional tools, such as the screws of the prior art, to anchor the construction elements according to the invention to the concrete of the tunnel.

In a further embodiment of the construction, the construction comprises a ceiling and sidewalls, wherein the construction elements are anchored to the concrete in the ceiling and/or the sidewalls. Preferably, the anchoring direction is vertical or substantially vertical at the ceiling and/or horizontal or substantially horizontal at the sidewalls. The construction elements can thus be suspended from the concrete at the ceiling and retained to and supported by the concrete at the sidewalls.

According to a fourth aspect, the invention provides a method for covering a concrete surface with the use of a plurality of the aforementioned construction elements, wherein the method comprises the steps of:
casting a concrete into a concrete layer onto the respective second sides of the plurality of construction elements;
allowing parts of the concrete layer to enter and fill at least some of the volumes defined by the circumferential walls of the respective anchoring elements of each of the plurality of construction elements; and
allowing the concrete to cure within the plurality of anchoring elements;

wherein the locking surfaces of the respective anchoring elements stop movement of the concrete from the base towards the opening, after the concrete has cured, in the anchoring direction normal to the second side.

A tunnel constructed in this manner can be constructed more easily, as no additional elements other than the construction elements themselves are required to securely anchor the construction elements to the concrete. Therefore, the screws according to the prior art can be dispensed with all together, reducing the time and efforts involved with anchoring the construction elements.

In an embodiment the method prior to casting the concrete comprises the step of providing a formwork for receiving the concrete, wherein the method further comprises the step of arranging the plurality of construction elements with their respective first sides onto the formwork. The construction elements can thus be placed in their respective positions with respect to the tunnel prior to the casting of the concrete.

In a further embodiment the method comprises the step of removing the formwork after the concrete has cured, wherein the plurality of construction elements are supported on the formwork prior to the curing of the concrete and wherein the plurality of construction elements are fully and/or solely supported by the parts of the cured concrete in the plurality of anchoring elements after the curing of the concrete. Again, the tunnel can be constructed without using additional tools, such as the screws of the prior art, to anchor the construction elements according to the invention to the concrete of the tunnel.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a front view of a tunnel with a concrete layer and a plurality of construction elements according to a first embodiment of the invention;

FIG. 2 shows an isometric view of a part of the concrete layer with one of the construction elements according to FIG. 1;

FIGS. 3 and 4 show isometric views in cross section of construction element with and without the concrete layer, according to the lines and IV-IV, respectively;

FIGS. 5-8 show isometric views of alternative construction elements according to a second, third, fourth and fifth embodiment of the invention, respectively; and

FIGS. 9-14 show further alternative construction elements according to a sixth, seventh, eighth, ninth, tenth and eleventh embodiment of the invention, respectively.

### DETAILED DESCRIPTION OF THE INVENTION

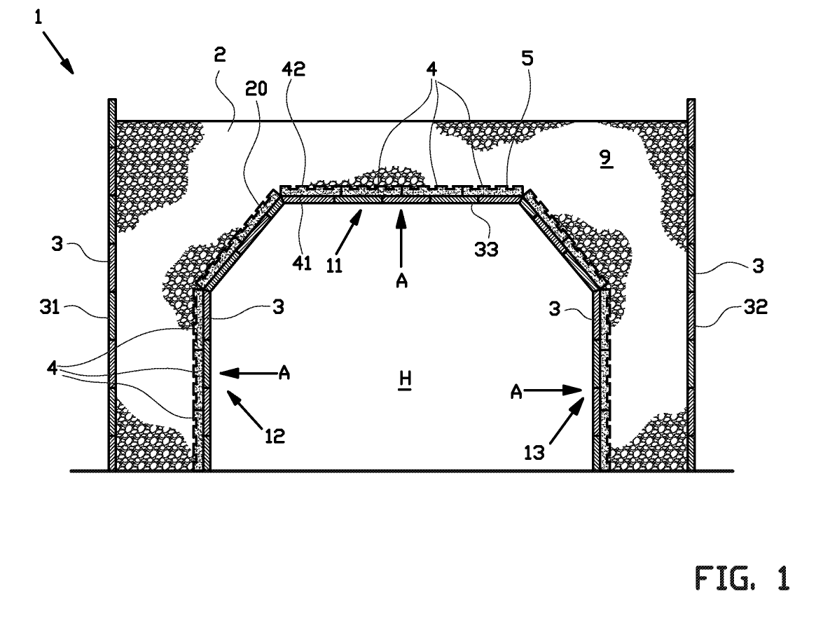

FIG. 1 shows a tunnel 1 with a typical tunnel construction, having a ceiling 11 and sidewalls 12, 13. In this exemplary embodiment, the tunnel 1 has chamfered sections 14, 15 between the ceiling and the respective sidewalls 12, 13. The tunnel 1 defines an internal tunnel space H. The tunnel construction is constructed by casting concrete 9 into a form-work 3 and by letting said concrete 9 cure into a concrete layer 2. The form-work 3 can subsequently be removed. The form-work 3 comprises outer walls 31, 32 that define the sides of the sidewalls 12, 13 of the tunnel 1 that face away from the internal tunnel volume H and an inner wall 33 that defines the sides of the ceiling 11 and the sidewalls 12, 13 that face towards the internal tunnel volume H.

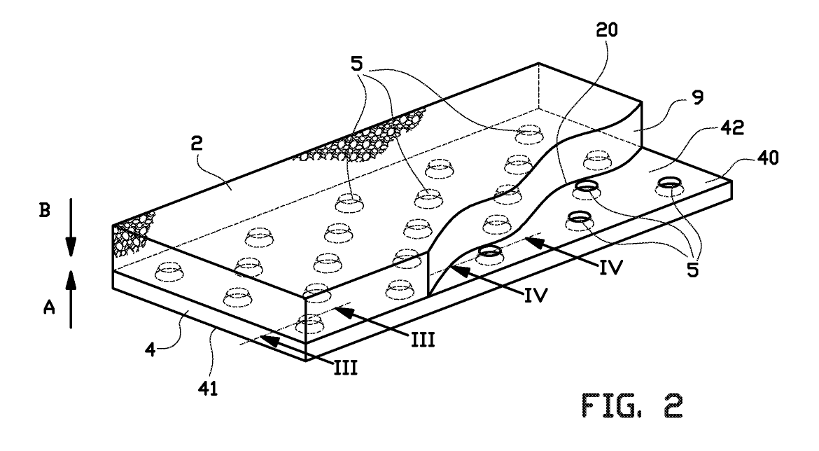

As shown in FIG. 1, the concrete layer 2 is lined on the inside, i.e. concrete surface 20 of the concrete layer 2 that faces the internal tunnel volume H, with a plurality of construction elements 4 according to an exemplary first embodiment of the invention. The plurality of construction elements 4 are placed on the inner wall 33 of the form-work 3 prior to the casting of the concrete 9. One of the construction elements 4 is shown in more detail in FIG. 2. Each construction element 4 comprises a plate-like body 40 with a first side 41 that faces away from the concrete layer 2 and a second side 42 opposite to the first side 41 that faces the concrete layer 2. As shown in FIG. 1, the construction elements 4 are arranged to be placed with their respective first sides 41 onto or in abutment with the inner wall 33 of the form-work 3 and with their respective second sides 42 facing towards the concrete 9 when it is being casted. For fireproofing applications, the plate-like body 40 comprises fireproofing material. The plate-like body 40 may for example be a non-combustible mineral board, preferably reinforced with fibers and/or fillers. When applied to the inside of the tunnel 1, the fireproofing construction elements 4 can reduce the structural damage to the concrete layer 2 of the tunnel 1 in case of fire in the internal tunnel volume H.

As best seen in FIG. 2, each construction element 4 is provided with a plurality of anchoring elements at its second side 42 for anchoring the respective construction element 4 to the concrete 9 when it is being casted. Preferably, the construction elements 4 and/or the anchoring elements 5 are reproducible. In particular, the anchoring elements 5 are the same for each construction element 4. More preferably, at least two of the anchoring elements 5 of the construction element 4 are equally shaped or identical. Most preferably, all anchoring elements 5 of the construction element 4 are equally shaped or identical. The plurality of anchoring elements 5 are distributed over the entire surface area of the second side 42. Preferably, the plurality of anchoring elements 5 are distributed evenly to provide arrive at a constant number of anchoring elements 5 per square meter of the plurality of construction elements 4. More preferably, the anchoring elements 5 are provided in each construction element 4 in a reproducible pattern. Most preferably, each construction element 4 comprises at least five of the anchoring elements 5 per square meter.

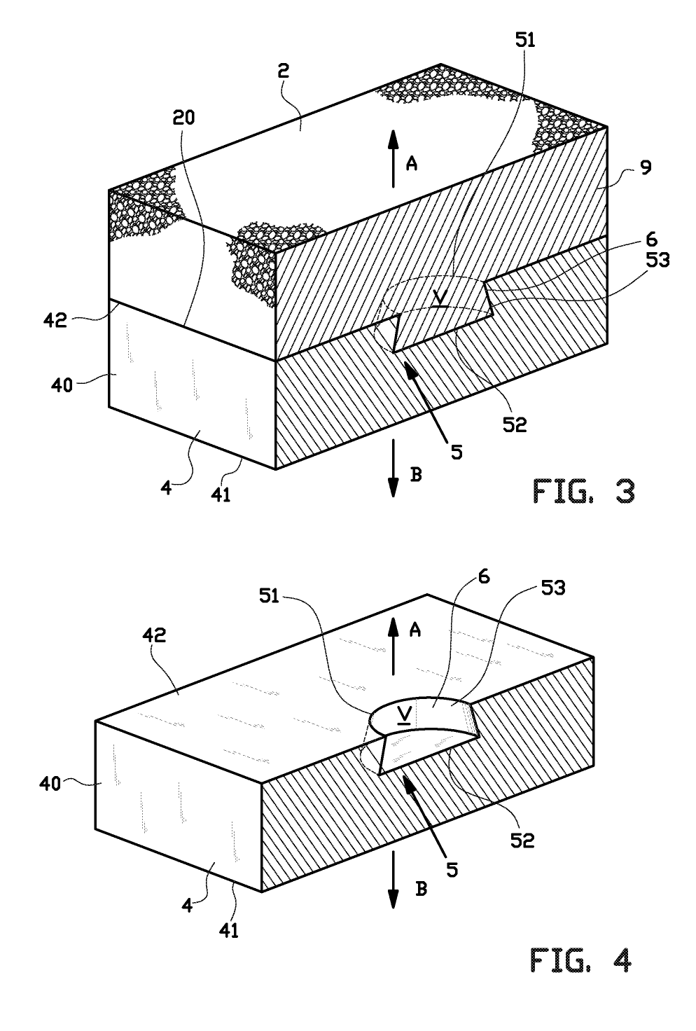

One of the anchoring elements 5 is shown in cross section in FIGS. 3 and 4, with and without the concrete layer 2, respectively. Each anchoring element 5 comprises an opening 51 in the second side 42, a base 52 that is recessed with respect to the second side 42 towards the first side 41 and a circumferential wall 53 extending between the opening 51 and the base 52. The base 52 is recessed with respect to the second side 42 over a distance of only one or two centimeters, to leave enough material below the base 52 to preserve the structural integrity of the plate-like body 40. Preferably, the base 52 is recessed with respect to the second side 42 over a distance of at least five millimeters, preferably at least ten millimeters. In this exemplary first embodiment, both the opening 51 and the base 52 have the same geometric shape; a circle. The opening 51 and the base 52 both extend concentrically with respect to each other. The base 52 has a larger diameter than the opening 51, with the circumferential wall 53 expanding and/or diverging from the opening 51 towards the base 52. Preferably, the diameter of the opening 51 is at least ten millimeters, more preferably at least twenty millimeters, most preferably at least thirty millimeters. The opening 51 is arranged to be open to or in fluid communication with the concrete 9 when it is being casted. The circumferential wall 53 defines a volume V for receiving and holding the concrete 9 into the anchoring element 5 when the concrete 9 enters the anchoring element 5 through the opening 51 thereof.

The anchoring elements 5 according to the invention are preferably formed according to a predetermined shape. More preferably, the predetermined shape of the anchoring elements 5 is (pre-)programmed in a control unit that is arranged for controlling a computer aided manufacturing process of the anchoring elements 5, e.g. CNC drilling, CNC milling or additive manufacturing.

As best seen in FIGS. 3 and 4, each anchoring element 5 comprises a locking surface 6 that is arranged for preventing, restricting and/or stopping retraction or movement of the concrete 9, once or after it has cured, from the base 52 towards the opening 51 in an anchoring direction A normal or substantially normal to the second side 42. The locking surface 6 faces the volume V that is defined by the circumferential wall 53 of the respective anchoring element 5. In this exemplary first embodiment, the locking surface 6 is formed by or is the circumferential wall 53. The locking surface 6 extends under an oblique angle with respect to and diverging from the anchoring direction A in an abutment direction B opposite to the anchoring direction A, preferably at an angle in a range of thirty to eighty degrees, and most preferably in a range of forty to seventy degrees. The locking surface 6 is arranged to contact, abut or exert a stopping force onto the cured concrete 9 in the abutment direction B.

As shown in cross section in FIG. 3, at least a part of the plate-like body 40 extends between the at least locking surface 6 and the second side 42 in the anchoring direction A. The locking surface 6 therefore geometrically encloses or locks in a part of the cured concrete 9 inside the volume V as defined by the circumferential wall 53 and prevents or stops retraction or movement of part of the cured concrete 9 in the anchoring direction A. The part of the cured concrete 9, and the concrete layer 2 associated therewith via the opening 51, is therefore retained, fixed and/or anchored to the construction element 4 at the respective anchoring element 5. Likewise, the construction element 4 is retained, fixed and/or anchored to the concrete layer 2 by the parts of the cured concrete 9 inside at least some of the volumes V of its respective anchoring elements 5.

After the concrete 9 has cured sufficiently, the form-work 3 as shown in FIG. 1 can be removed, after which the construction element 4 is supported fully and/or solely by the parts of the cured concrete 9 inside the anchoring elements 5. For the ceiling 11 of the tunnel 1, the anchoring direction A is vertical or substantially vertical, which means that the construction elements 4 that line the ceiling 11 are suspended from and anchored to the ceiling 11 with respect to said vertical anchoring direction A. At the sidewalls 12, 13 of the tunnel 1, the anchoring direction A is horizontal or substantially horizontal, which means that the construction elements 4 that line the sidewalls 12, 13 are retained to the sidewalls 12, 13 in said horizontal anchoring direction A and are supported on the sidewalls 12, 13 in the vertical direction.

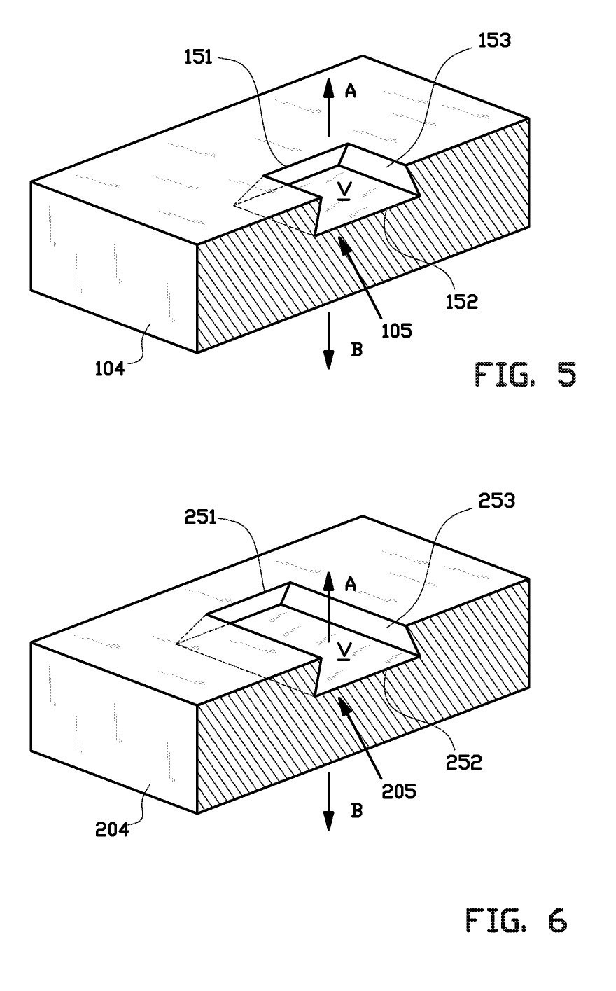

In this particular embodiment, the circular opening 51, the circular base 52 and the locking surface 6 provide the volume V with the shape of a truncated cone. In cross section, the shape of the volume V may be considered as a dove-tail, providing a dove-tail joint or connection between the cured concrete 9 and the construction element 4 at the anchoring element 5. It will be apparent to the person skilled in the art that many variations would yet be encompassed by the scope of the present invention, as illustrated by the various alternative embodiments as shown in FIGS. 5-8 and 9-14.

The alternative construction elements according to the embodiments in FIGS. 5-8 and 9-14 each substantially correspond to the construction element 4 according to the first embodiment of the invention, apart from any differentiating features as mentioned below.

FIGS. 5-8 show a number of exemplary, alternative embodiments according to the invention, having variations in terms of the geometric shape of the anchoring elements.

FIG. 5 shows an alternative construction element 104 according to a second embodiment of the invention, in which the anchoring elements 105 are provided with a square opening 151, a square base 152 and a four-sided circumferential wall 153 extending in between. The resulting volume V has the form of a truncated pyramid.

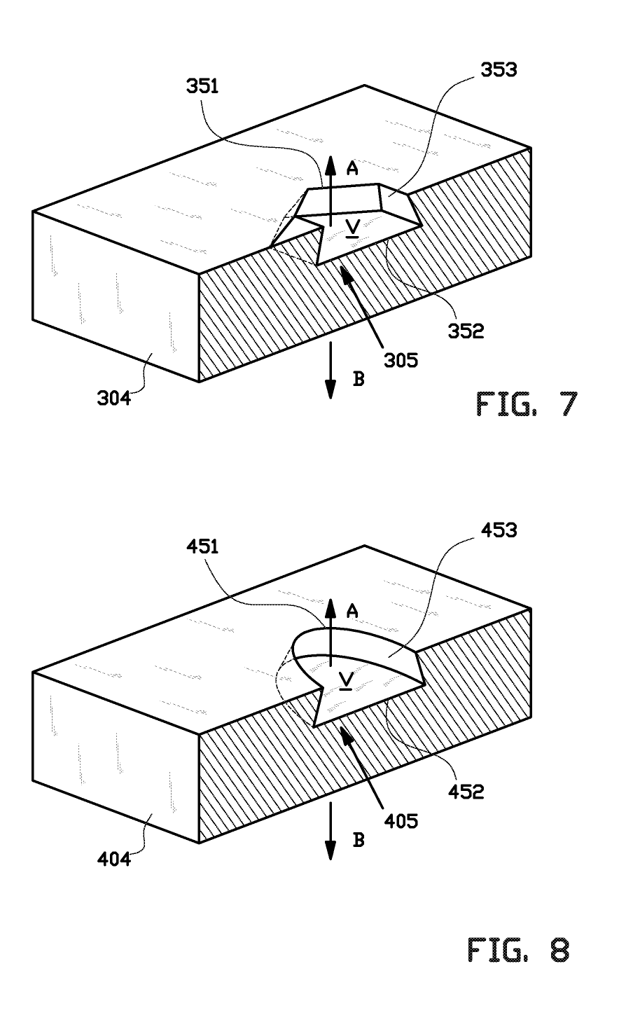

FIG. 6 shows an alternative construction element 204 according to a third embodiment of the invention, in which the anchoring elements 205 are provided with an elongated and/or rectangular opening 251, an elongated and/or rectangular base 252 and a four-sided circumferential wall 253 extending in between. The resulting volume V has the form of a truncated pyramid with unequal sides. FIG. 7 shows an alternative construction element 304 according to a fourth embodiment of the invention, in which the anchoring elements 305 are provided with a hexagon opening 351, a hexagon base 352 and a six-sided circumferential wall 353 extending in between. The resulting volume V has a hexagon cross section.

FIG. 8 shows an alternative construction element 404 according to a fifth embodiment of the invention, in which the anchoring elements 405 are provided with an oval opening 451, an oval base 452 and an oval circumferential wall 453 extending in between. The resulting volume V has an oval cross section.

As will be apparent from the aforementioned embodiments, the anchoring elements according to the invention can have various different geometric shapes, including but not limited to geometric shapes of the group comprising a circle, an oval, a triangle, a square, a rectangle, a pentagon, a hexagon, or any other polygon. The geometric shape may be symmetrical or asymmetrical. The opening and/or the base may also have different geometric shapes or a combination thereof. The geometric shapes may also be different for different anchoring elements of the same construction element.

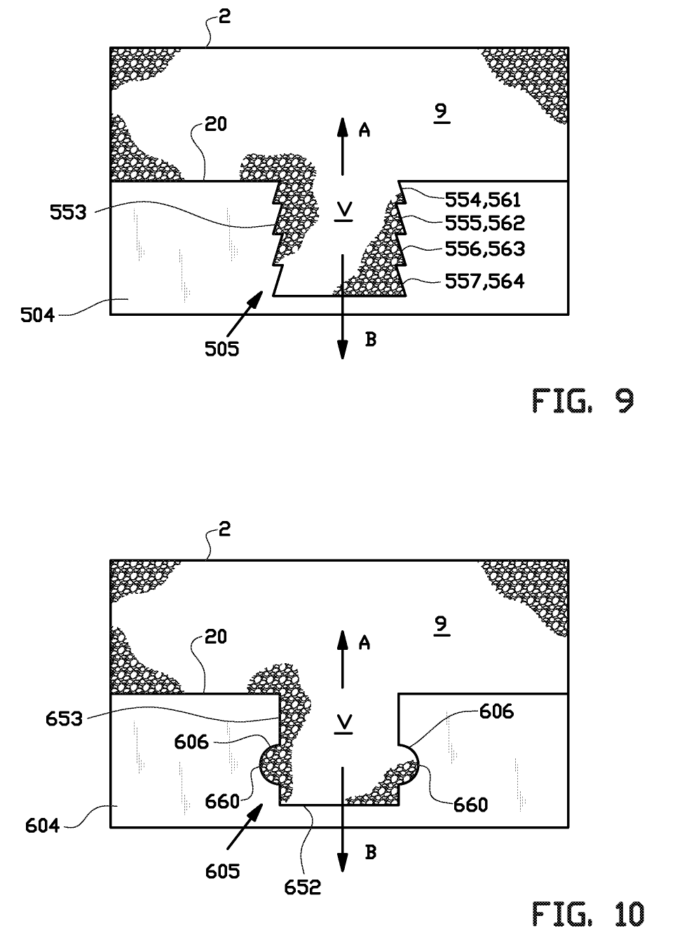

FIGS. 9-15 show further alternative embodiments according to the invention, having variations in terms of the formation, shape and/or orientation of the locking surface 6.

FIG. 9 shows an alternative construction element 504 according to a sixth embodiment of the invention, in which the anchoring elements 505 have a circumferential wall 553 that is divided into or provided with a plurality of wall sections 554, 555, 556, 557 which arranged consecutively in the anchoring direction A. Each wall section 554, 555, 556, 557 diverges from the opening 551 towards the base 552. Each wall section forms a locking surface 561, 562, 563, 564 that is arranged to individually abut the concrete 9 in the abutment direction B opposite to the anchoring direction A.

FIG. 10 shows an alternative construction element 604 according to a seventh embodiment of the invention, in which the anchoring elements 605 have a circumferential wall 653, wherein the locking surface 606 forms a recess 660 in the circumferential wall 653 extending in a direction transverse or perpendicular to the anchoring direction A. In this exemplary embodiment, the recess 660 is spaced apart from the base 652. Alternatively, the recess 660 may be arranged at the base 652 (not shown).

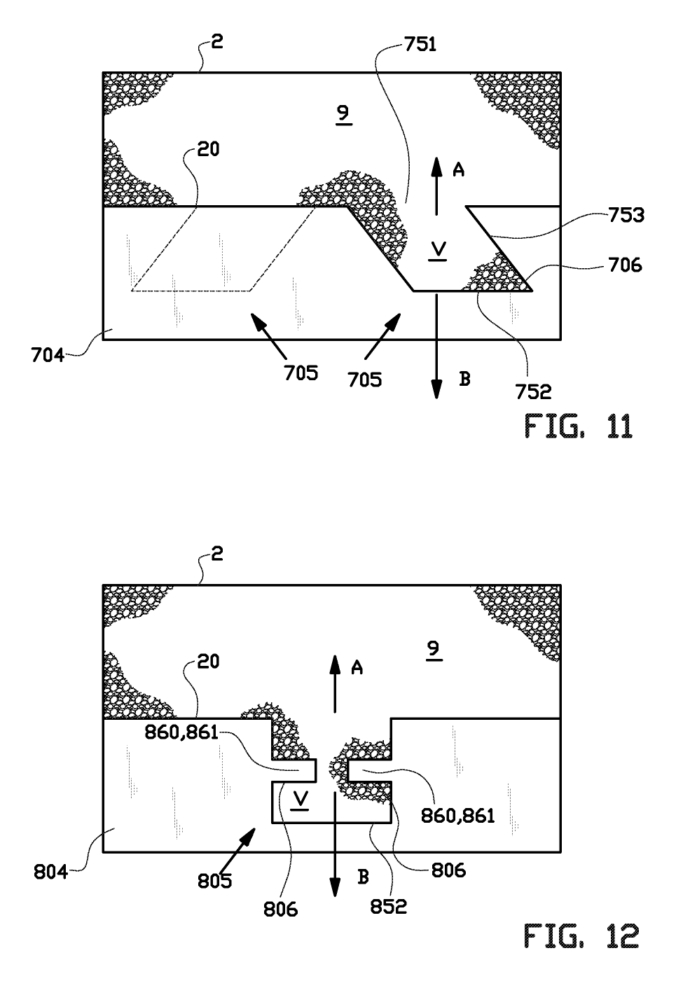

FIG. 11 shows an alternative construction element 704 according to an eighth embodiment of the invention, in which the anchoring elements 705 have a base 752 that is offset with respect to the opening 751 in a direction transverse or perpendicular to the anchoring direction A, resulting in circumferential wall 753 extending obliquely away from the opening 751 and defining a volume V that also extends obliquely with respect to the opening 751. The locking surface 706 in this embodiment is formed by the oblique wall section of the circumferential wall 753 that faces in the abutment direction B. The obliqueness should be sufficient to retain the construction element 704 on the part of the cured concrete 2, in particular in the direction of the obliqueness. Preferably, the bases 751 of at least two of the plurality of anchoring elements 705 are offset in different directions with respect to their respective openings and/or each other, as shown with dashed lines for another one of the anchoring elements 705. In this manner, movements of the construction element 704 with respect to the concrete layer 2 in the direction one of the oblique angles can be prevented.

FIG. 12 shows an alternative construction element 804 according to an ninth embodiment of the invention, in which the anchoring elements 805 have locking surface 806 that is formed by a protrusion 860 extending circumferentially along the inside of the circumferential wall 853 and protruding into the volume V. In this embodiment, the protrusion 860 is formed as or is a rim 861. The protrusion 860 is spaced apart from the base 852, so that concrete 9 may be locked in underneath. The locking surface 806 is formed by the side of the protrusion 860 that faces in the abutment direction B. The circumferential wall 853 may be cylindrical or substantially cylindrical.

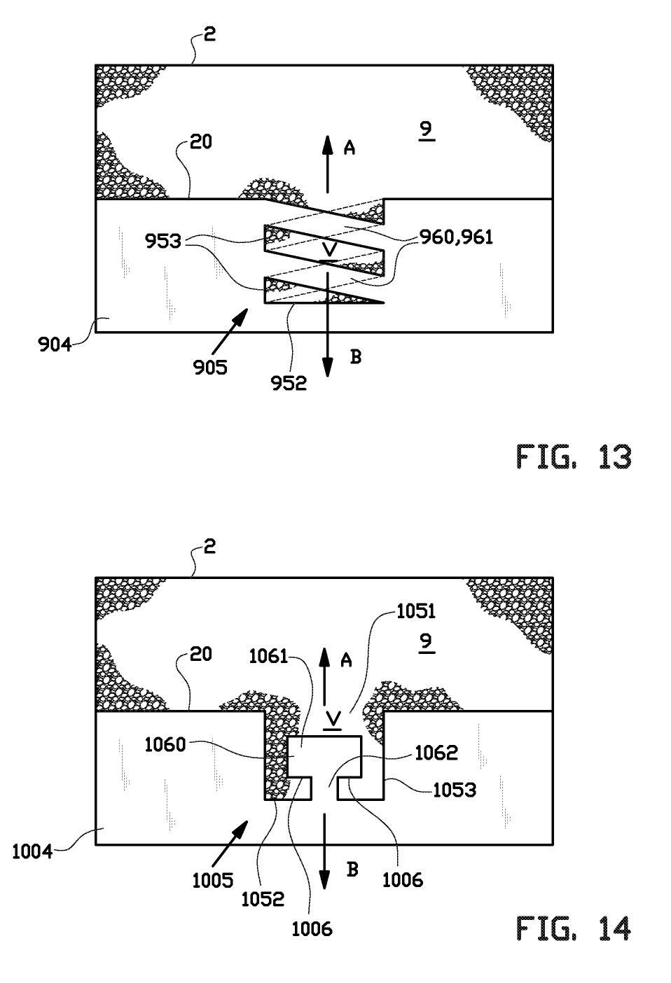

FIG. 13 shows an alternative construction element 904 according to an tenth embodiment of the invention, in which the anchoring elements 905 have locking surface 906 that is formed by a protrusion 960 extending helically along the inside of the circumferential wall 953 in the anchoring direction A and protruding into the volume V. Similar to the previous embodiment, the protrusion 960 is formed as or is a rim 961. The concrete 9 is locked in between subsequent revolutions of the helically extending protrusion 960 or between a revolution of the helically extending protrusion 960 and the base 952. The locking surface 906 is formed by the side of the protrusion 960 that faces in the abutment direction B. The circumferential wall 953 may be cylindrical or substantially cylindrical.

FIG. 14 shows an alternative construction element 1004 according to an eleventh embodiment of the invention, in which the anchoring elements 1005 have locking surface 1006 that is formed by a protrusion 1060 extending or protruding from the base 1052 upright and/or in the anchoring direction A towards the opening 1051. The protrusion 1060 is spaced apart from and/or not connected to the circumferential wall 1053. The protrusion 1060 is provided with a head 1061 that forms the locking surface 1006 and a body 1062 connecting the head 1061 to the base 1052. The locking surface 1006 is formed at the side of the head 1061 that faces in the abutment direction B. The circumferential wall 1053 may be cylindrical or substantially cylindrical.

Some of the construction elements, in particular the construction elements 804, 904, 1004 according to the latter three embodiments, can not easily be manufactured with traditional manufacturing techniques, but may instead be manufactured with additive manufacturing techniques, such as 3D printing. This may also allow on-site printing of custom-made construction elements. The applicant therefore also seeks protection for computer-readable media, such as an electronic file or a physical, electronic carrier (not shown), with computer-executable instructions that are adapted to cause a 3D printer to print a construction element according to any one of the aforementioned embodiments.

It is to be understood that the above description is included to illustrate the operation of the preferred embodiments and is not meant to limit the scope of the invention. From the above discussion, many further variations will be apparent to one skilled in the art that would yet be encompassed by the scope of the present invention.

For example, the same construction elements may be used to cover a concrete surface of another construction, for example a ceiling, wall or floor of a building.

In summary, the invention relates to a construction element for a tunnel, a tunnel comprising said construction element and a method for construction said tunnel. The construction element is provided with a plurality of anchoring elements for anchoring the construction element to the concrete when it is casted, wherein each anchoring element comprises an opening which is arranged to be in fluid communication with the concrete, a base that is recessed and a circumferential wall extending between the opening and the base, wherein the circumferential wall defines a volume for receiving the concrete into the anchoring element, wherein each anchoring element comprises at least one locking surface that faces said volume and that is arranged to stop movement of the concrete from the base towards the opening, after the concrete has cured, in an anchoring direction.

1-33. (canceled)

34. Construction element for covering a concrete surface, in particular a concrete surface of a tunnel, wherein the concrete surface is formed by casting concrete, the construction element comprises a plate-like body with a first side that is arranged to face away from the concrete when it is casted and a second side opposite to the first side that is arranged to face the concrete when it is casted, the construction element is provided with a plurality of anchoring elements at the second side for anchoring the construction element to the concrete when it is casted, each anchoring element comprises an opening in the second side, which opening is arranged to be in fluid communication with the concrete, a base that is recessed with respect to the second side towards the first side and a circumferential wall extending between the opening and the base, the circumferential wall defines a volume for receiving the concrete into the anchoring element, and each anchoring element comprises at least one locking surface that faces said volume and is arranged to stop movement of the concrete from the base towards the opening, after the concrete has cured, in an anchoring direction normal to the second side.

35. Construction element according to claim 34, wherein the at least one locking surface extends obliquely with respect to the anchoring direction.

36. Construction element according to claim 34, wherein the locking surface is formed by a wall section of the circumferential wall that diverges from the opening towards the base.

37. Construction element according to claim 34, wherein the base is larger than opening.

38. Construction element according to claim 37, wherein the base has the same geometric shape as the opening.

39. Construction element according to claim 38, wherein the volume at the at least one locking surface has the form of a truncated cone or a truncated pyramid.

40. Construction element according to claim 34, wherein the base is offset with respect to the opening in a direction transverse or perpendicular to the anchoring direction.

41. Construction element according to claim 40, wherein the bases of at least two of the plurality of anchoring elements are offset in different directions with respect to each other.

42. Construction element according to claim 34, wherein the at least one locking surface forms the entire circumferential wall.

43. Construction element according to claim 34, wherein the at least one locking surface forms a recess in the circumferential wall extending in a direction transverse or perpendicular to the anchoring direction.

44. Construction element according to claim 34, wherein the opening and/or the base have a geometric shape of the group comprising a circle, an oval, a triangle, a square, a rectangle, a pentagon, a hexagon, or any other polygon.

45. Construction element according to claim 34, wherein the plate-like body comprises fireproofing material, preferably non-combustible mineral board reinforced with fibers and/or fillers.

46. Construction, in particular a tunnel, comprising a cured concrete layer with a concrete surface and a plurality of construction elements according to claim 34 covering said concrete surface, wherein the construction elements are anchored to the cured concrete layer by parts of the cured concrete layer extending in at least some of the volumes of the respective anchoring elements.

47. Construction according to claim 46, wherein the construction elements are fully and/or solely supported by the parts of the cured concrete layer in the plurality of anchoring elements after the curing of the concrete.

48. Method for covering a concrete surface with the use of a plurality of construction elements according to claim 34, wherein the method comprises the steps of:
providing a formwork for receiving the concrete
arranging a plurality of construction elements with their respective first sides onto the formwork;
casting a concrete into a concrete layer onto the respective second sides of the plurality of construction elements;
allowing parts of the concrete layer to enter and fill at least some of the volumes defined by the circumferential walls of the respective anchoring elements of each of the plurality of construction elements; and
allowing the concrete to cure within the plurality of anchoring elements;
wherein the locking surfaces of the respective anchoring elements stop movement of the concrete from the base towards the opening, after the concrete has cured, in the anchoring direction normal to the second side.
